(19) United States
(12) Patent Application Publication
(10) Pub. No.: US 2024/0212176 A1
(43) Pub. Date: Jun. 27, 2024

(54) METHOD OF GENERATING 3D SCAN DATA THROUGH BROADBAND LIDAR SCAN-BASED IMAGE INTERPOLATION AND APPARATUS FOR PROVIDING PLATFORM

(71) Applicant: LuxPM Inc., Seongnam-si (KR)

(72) Inventor: Youngwung Yu, Seongnam-si (KR)

(73) Assignee: LuxPM Inc., Seongnam-si (KR)

(21) Appl. No.: 18/456,207

(22) Filed: Aug. 25, 2023

(30) Foreign Application Priority Data
Dec. 27, 2022 (KR) 10-2022-0185505

(51) Int. Cl. G06T 7/33; G06T 7/40; G06T 15/04; G06T 17/20; G06V 20/64

(52) U.S. Cl. CPC G06T 7/33; G06T 7/40; G06T 15/04; G06T 17/20; G06V 20/64; G06T 2200/04; G06T 2207/10028; G06T 2207/20221

(57) ABSTRACT

Provided is a method of generating three-dimensional (3D) scan data in which a texture is implemented through image registration based on a scan of a broadband light detection and ranging (lidar) scanner, the method including: when a scanning target region is scanned by the lidar, obtaining first data that is a 3D image generated by scanning the scanning target region with the lidar scanner; obtaining second data that is a 2D image generated by photographing the scanning target region with a camera; obtaining first feature data associated with a structure of an object in the second data; obtaining second feature data associated with a texture of the object in the second data; and in response to a change value of the first feature data being greater than a preset reference value, merging the second feature data with the first data to generate third data.

### CROSS-REFERENCE TO RELATED APPLICATION

This application claims priority to and the benefit of Korean Patent Application No. 10-2022-0185505, filed on Dec. 27, 2022, the disclosure of which is incorporated herein by reference in its entirety.

### BACKGROUND

### 1. Field of the Invention

The present invention relates to a method of generating 3D scan data and an apparatus for providing a platform. More specifically, the present invention relates to a 3D scan data generation method capable of rapidly generating a 3D image with a higher resolution by interpolating broadband light detection and ranging (LiDAR) scan data and image data.

### 2. Discussion of Related Art

Conventionally, in order to produce a three-dimensional (3D) model of an object, a 3D modeling task has been performed using a program such as a computer-aided design (CAD). Since a certain level of skill is required to perform such a task, 3D modeling tasks have been mostly performed by experts. Accordingly, it takes significant amount of time and money to perform a 3D modeling task, and the quality of the produced 3D models greatly varies depending on the operator.

Recently, a technology for automating 3D modeling based on photographs or images of a target object captured from various angles has been introduced, making it possible for a 3D model to be produced within a short period of time. However, general 3D modeling automation technologies require a process of extracting feature points from an image, and this scheme has a drawback that feature points are not properly extracted according to the characteristics of the object, or a 3D model in which the shape of the object is not accurately reflected is generated.

### SUMMARY OF THE INVENTION

The present invention is directed to providing an image interpolation method capable of generating high-quality 3D scan data in a short time.

The technical objectives of the present invention are not limited to the above, and may be variously expanded without departing from the technical concept and field of the present invention.

According to an aspect of the present invention, there is provided a method of generating three-dimensional (3D) scan data in which a texture is implemented through image registration based on a scan of a broadband light detection and ranging (LiDAR) scanner, the method including: obtaining first data that is a 3D image generated by scanning the scanning target region with the LiDAR scanner; obtaining second data that is a 2D image generated by photographing the scanning target region with a camera; obtaining first feature data associated with a structure of an object in the second data; obtaining second feature data associated with a texture of the object in the second data; and in response to a change value of the first feature data being greater than a preset reference value, and generating third data by merging the second feature data with the first data.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic diagram illustrating a system for providing a virtual space-based real-time communication platform according to an embodiment of the present application;

FIG. 2 is a diagram illustrating operations of a platform server (300) according to an embodiment of the present application;

FIG. 3 is a diagram for describing a method of interpolating an image according to an embodiment of the present application;

FIG. 4 is a flowchart for describing a process of generating 3D scan data according to an embodiment of the present application;

FIG. 5 is a diagram for describing an aspect of recognizing an object in a virtual space generated in a platform server according to an embodiment of the present application; and

FIG. 6 is a diagram for describing a real-time communication interface based on objects recognized in a platform server and an object list according to an embodiment of the present application.

### DETAILED DESCRIPTION OF EXEMPLARY EMBODIMENTS

The above objects, features and advantages of the present invention will become more apparent from the following detailed description taken in conjunction with the accompanying drawings. The present invention may be modified in various ways and may have various embodiments. Hereinafter, specific embodiments will be illustrated in the drawings and described in detail.

In the following description, like reference numbers essentially designate like elements. In addition, elements having the same function within the scope of the same idea shown in the drawings of each embodiment will be described using the same reference numbers, and overlapping description will be omitted.

In addition, when it is determined that the detailed description of a known function or configuration related to the present invention may unnecessarily obscure the object matter of the present invention, the detailed description thereof will be omitted. In addition, a number (e.g., first, second, etc.) used in the description of the present invention is merely an identifier for distinguishing one component from another component.

The suffixes “module” and “unit” for components used in the following description are given or used together in consideration of ease of writing the specification and do not have distinct meanings or roles by themselves.

In the embodiments below, the singular forms are intended to include the plural forms as well, unless the context clearly indicates otherwise.

It will be further understood that the terms “comprises,” “comprising,” “includes,” and/or “including,” used herein specify the presence of stated features, integers, steps, operations, elements, and/or components but do not preclude the possibility of the presence or addition of one or more other features, integers, steps, operations, elements, components, and/or groups thereof.

In the accompanying drawings, the size of each component shown in the drawings may be exaggerated or reduced for convenience of description. For example, the size and thickness of each component shown in the drawings are arbitrarily shown for convenience in description, and the present invention is not necessarily limited to those shown.

When an embodiment is otherwise implementable, specific processes may be performed in an order different from the described order. For example, two processes described in succession may be performed concurrently or in reverse order.

In the following embodiments, it should be understood that when an element is referred to as being “connected” to another element, the element may be directly connected to another element or indirectly connected to another element with intervening elements.

For example, when an element is referred to as being electrically connected to another element, the electrical connection may be direct or indirect with intervening elements.

A light detection and ranging (LiDAR) scanner may scan a wide location through a broadband LiDAR sensor to generate three-dimensional (3D) data of a scanned region. Here, the 3D data is a 3D image generated by scanning a specific region. The LiDAR scanner may be equipped with a communication module to communicate with a terminal in a wireless manner.

A camera may capture an image of a specific object through photographing to generate two-dimensional (2D) data of the photographed object. Here, the 2D data is a 2D image generated by photographing a specific target. The camera may be equipped with a communication module to communicate with a terminal in a wireless manner.

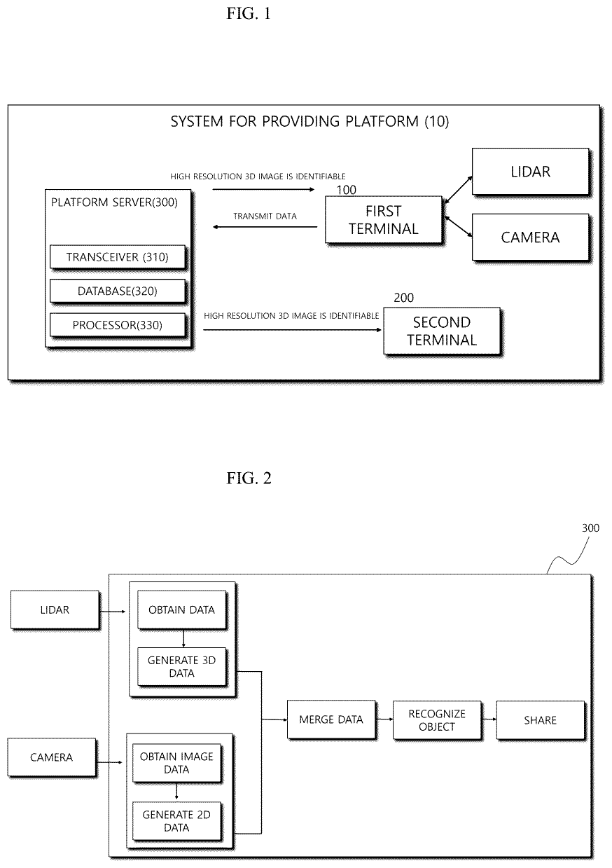

Hereinafter, a method of generating 3D scan data, and an apparatus and system for providing a virtual space-based real-time communication platform according to the present application will be described with reference to with FIGS. 1 to 6.

FIG. 1 is a schematic diagram illustrating a system for providing a virtual space-based real-time communication platform according to an embodiment of the present application.

A system 10 for providing a platform is a system configured such that a user who wants to three-dimensionally scan a specific area transmits data about a scanning target region to a platform server 300 to generate 3D scan data, the 3D scan data is shared with other users, and communication is performed with the other users based on the data.

In particular, the system 10 for providing a platform according to the present application is characterized by providing high-quality 3D scan data in a short time.

The system 10 for providing a platform according to an embodiment of the present application may include a first terminal 100, a second terminal 200 and a platform server 300.

The first terminal 100 is a terminal used by a user, who wants to perform a 3D scan on a target region, to obtain data, and may be provided in various types, such as a general computer, a smart phone, a tablet personal computer (PC), and the like. The second terminal 200 is a terminal used by a user, who wants to obtain generated 3D scan data, and may be provided in various types, such as a general computer, a smart phone, and a tablet PC.

The first terminal 100 may obtain scan data from a scanning target region using a LiDAR scanner and/or a camera. According to an embodiment, the first terminal 100 may be implemented as an integrated device including a LiDAR scanner and a camera, or the first terminal 100 may be a separate device separated from a LiDAR scanner and/or camera and connected to the LiDAR scanner and/or camera through a wired or wireless communication network.

The second terminal 200 may receive data generated from the platform server 300 through a network. As needed, the first terminal 100 and the second terminal 200 may generate a real-time conversation with respect to the generated data.

As needed, the first terminal 100 and the second terminal 200 may be configured of at least one terminal.

The platform server 300 is connected to the first terminal 100 and the second terminal 200 through a wired or wireless communication network. The platform server 300 generates 3D scan data in a virtual space using data received from the first terminal 100. As needed, the platform server 300 may receive 3D image data generated by scanning a scanning target region with the LiDAR scanner of the first terminal 100 and 2D image data generated by photographing the scanning target region with the camera, and generate 3D scan data in a virtual space using the received data.

As needed, the platform server 300 may recognize objects within the generated 3D scan data, generate an object list using the recognized objects, and provide a real-time communication interface based on the object list.

Referring to FIG. 1, the platform server 300 according to an embodiment of the present application may include a transceiver 310, a database 320, and a processor 330.

The transceiver 310 of the platform server 300 may communicate with an arbitrary external device and internal server. For example, the platform server 300 may receive, from the first terminal 100, a 3D image generated by scanning a scanning target region and 2D image data captured by a camera through the transceiver 310. In addition, the platform server 300 may transmit 3D scan data generated by merging the 3D image and the 2D image data to an arbitrary second terminal 200 through the transceiver 310.

The platform server 300 may transmit and receive various types of data by accessing a network through the transceiver 310. The transceiver 310 may largely include a wired type transceiver and a wireless type transceiver. Since the wired type transceiver and the wireless type transceiver have respective advantages and disadvantages, both the wired type transceiver and the wireless type transceiver may be provided in the platform server 300 depending on circumstances. Here, the wireless type transceiver may mainly use a wireless local area network (WLAN)-based communication method, such as wireless fidelity (WiFi). Alternatively, the wireless type transceiver may use a cellular communication method, e.g., a Long Term Evolution (LTE)- or 5G-based communication method. However, the wireless communication protocol is not limited to the above example, and any suitable wireless type communication method may be used. In the case of a wired type transceiver, local area network (LAN) or Universal Serial Bus (USB) communication is used as a representative example and other methods are also possible.

The platform server 300 may store the data obtained from the first terminal 100 in the database 320 and manage the stored data, and store the 3D scan data generated through the platform server 300 in the database 320 and manage the stored 3D scan data. The database 320 may store various types of information. Examples of the database 320 may include a hard disk drive (HDD), a solid-state drive (SSD), a flash memory, a read-only memory (ROM), a random-access memory (RAM), and the like. The database 320 may be provided in a form embedded in the platform server 300 or in a detachable form. The database 320 may store various types of data required for the operation of the platform server 300, including an operating system (OS) for driving the platform server 300 or a program for operating each component of the platform server 300.

The processor 330 may control overall operations of the platform server 300. For example, the processor 330 may control overall operations of the platform server 300, such as an operation of merging data to be described below, and the like. Specifically, the processor 330 may load a program for overall operations of the platform server 300 from the database 320 and execute the loaded program. The processor 330 may be implemented as an application processor (AP), a central processing unit (CPU), a microcontroller unit (MCU), or the like by hardware or software or a combination of hardware and software. In this case, in terms of hardware, the processor may be provided in the form of an electronic circuit that processes electrical signals to perform a control function, and in terms of software, the processor may be provided in the form of a program or code that drives a hardware circuit.

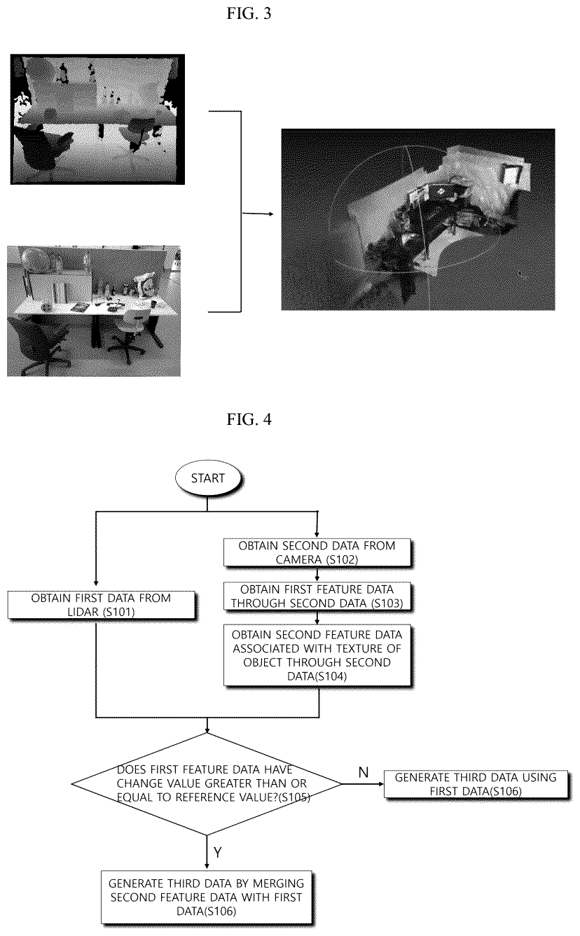

Hereinafter, operations of the platform server 300 according to an embodiment of the present application will be described in more detail with reference to FIGS. 2 and 3. FIG. 2 is a diagram illustrating operations of a platform server 300 according to an embodiment of the present application, and FIG. 3 is a diagram for describing a method of interpolating an image according to an embodiment of the present application.

The platform server 300 according to an embodiment of the present application may generate 3D scan data in which texture is implemented through image registration based on a scan of a broadband LiDAR scanner. In this case, the platform server 300 may align a 3D image generated by scanning a scanning target region with a LiDAR scanner with 2D image data generated by photographing with a camera to generate 3D scan data in a virtual space.

The platform server 300 according to an embodiment of the present application may obtain data from an external terminal. More specifically, the platform server 300 may obtain data obtained by scanning a scanning target region using a LiDAR scanner and a camera from the first terminal. Here, the data generated by scanning the scanning target region with a LiDAR scanner may be RGB-D (depth) data or various forms of 3D image data, and the data generated by photographing the scanning target region with a camera may be 2D image data.

According to an embodiment, RGB-D data of a scanning target region may be obtained using LiDAR. As needed, the platform server 300 may process the obtained RGB-D data to generate 3D image data. According to an embodiment of the present application, the platform server 300 may generate 3D image data using depth data among the obtained RGB-D data. When 3D image data is generated using the depth data as described above, a 3D shape of the scanning target region may be obtained more rapidly.

Hereinafter, a 3D image obtained through LIDAR is referred to as first data, and a 2D image generated by photographing with a camera is referred to as second data.

As needed, the first data may have a resolution lower than that of the second data. This is to provide high-quality 3D scan data while increasing the speed of data merging.

The platform server 300 according to an embodiment of the present application may obtain first feature data and second feature data from the second data. The first feature data is data associated with the structure of an object, and the second feature data is data associated with the texture of an object. The first feature data refers to data for determining the degree of flatness of the surface.

More specifically, the platform server 300 may divide the object of the second data into a form of a polygon mesh to obtain data associated with the structure of the object, and obtain first feature data associated with the structure of the object from elements constituting the polygon mesh. The first feature data associated with the structure refers to geometrical information related to the object, and data related to a color of the polygon mesh, the number of edges of the polygon mesh, the degree of connection of the edges of the polygon mesh, a vector value of the polygon mesh, a color change of the polygon mesh, and the like.

The second feature data is data associated with the texture of the object and may be a surface image of the object.

According to another embodiment of the present application, the platform server 300 may classify the degree of flatness of the surface of an object based on artificial intelligence (AI). That is, AI may identify the degree of flatness of the surface using the obtained second data, and the degree of flatness of the surface identified through AI may be quantified.

The platform server 300 according to an embodiment of the present application may, when a change value of the first feature data is greater than a preset reference value, merge the second feature data with the first data to generate a virtual space or third data.

The change value of the first feature data is a value indicating the degree of flatness of the surface of the object. A larger change value represents a surface that is less flat, and a smaller change value represents a surface that is flatter. When the reference value is set to be smaller, higher quality 3D scan data is provided, and the time required to generate the data is increased. Accordingly, the user may set the reference value according to his/her needs.

That is, the platform server 300 merges the second feature data having a high resolution with the first data to generate third data when the change value of the first feature data is greater than a preset reference value, and otherwise, does not merge the second feature data with the first data. A larger change value of the first feature data indicates a greater change in the structure of the object and more unevenness, and in this case, high-quality second feature data is merged with the first data, thereby obtaining high-resolution 3D scan data. In addition, when the change value of the first feature data is not large and the surface is flat, 3D scan data is constructed using the existing first data, thereby improving the 3D data scanning speed.

FIG. 5 is a diagram for describing an aspect of recognizing an object in a virtual space generated in a platform server according to an embodiment of the present application.

Referring to FIG. 5, the platform server 300 according to an embodiment of the present application may, upon generation of a virtual space, recognize at least one object in the virtual space and generate an object list using the recognized objects. This is a technology for recognizing a generated object based on AI, and may include a pre-trained AI neural network.

The object list may be a list of object names generated by recognizing an object located in a scanning target region. For example, the first terminal may scan an office, in which a chair, a desk, a computer, a monitor, a keyboard, and the like present in the office are scanned and recognized, and each of the chair, desk, computer, monitor, keyboard, and the like are listed, thereby generating an object list.

In the present invention, AI refers to a technology that mimics human learning ability, reasoning ability, perception ability, and the like, and implementing the abilities with a computer, and may include concepts, such as machine learning (ML), symbolic logic, and the like. ML is an algorithm technology that classifies or learns the characteristics of pieces of input data by itself. AI technology, as an ML algorithm, may analyze input data, learn the result of the analysis, and make judgments or predictions based on the result of the learning. In addition, technologies that mimic the functions of the human brain, such as recognition and judgment, using an ML algorithm, may also be understood as a category of AI. For example, AI may include technical fields, such as linguistic understanding, visual understanding, inference/prediction, knowledge expression, and motion control.

ML may refer to processing that trains a neural network model using an experience of processing data. Through ML, computer software improves its data processing capabilities. A neural network model is constructed by modeling a correlation between data, and the correlation may be expressed by a plurality of parameters. The neural network model extracts features from given data and analyzes the extracted features to derive a correlation between data, and the parameters of the neural network model are optimized as this process is repeated, which is referred to as ML. For example, a neural network model may learn a mapping (a correlation) between an input and an output with respect to data given as an input/output pair.

Alternatively, even when only input data is given, the neural network model may derive a regularity between given data to learn the correlation.

An AI learning model or a neural network model may be designed to embody a human brain structure on a computer, and may include a plurality of network nodes that simulate the neurons of a human neural network while having weights. The plurality of network nodes may have a connection relationship therebetween by simulating synaptic activities of neurons that transmit and receive signals through synapses. In the AI learning model, the plurality of network nodes may be located in layers of different depths and transmit and receive data according to a convolutional connection relationship. The AI learning model may be, for example, an artificial neural network model, a convolutional neural network (CNN) model, and the like. As an embodiment, the AI learning model may be subjected to machine learning according to methods, such as supervised learning, unsupervised learning, reinforcement learning, and the like.

ML algorithms for performing ML may employ a decision tree, a Bayesian Network, a support vector machine, an artificial neural network, Ada-boost, a perceptron, genetic programming, clustering, and the like.

Among the ML algorithms, a CNN is a type of multilayer perceptron designed to use minimal preprocessing. A CNN is composed of a single or multiple convolution layers and general artificial neural network layers on top of the single or multiple convolution layers, and additionally utilizes weights and pooling layers. Such a structure allows CNN to fully utilize input data with a 2D structure. In comparison with other deep learning structures, a CNN shows remarkable performance in both image and audio domains. CNNs may also be trained via standard back-propagation. CNNs have a benefit of being easily trained compared to other feedforward artificial neural network techniques and using fewer parameters.

Convolutional networks are neural networks that include sets of nodes having bound parameters. The increasing size of available training data and the availability of computational power, combined with algorithmic advances, such as discriminative linear units and dropout training, have led to great improvement in various computer vision tasks. With huge datasets, such as those available for many current tasks, overfitting is not important, and a larger network size leads to higher test accuracy. Optimal use of computing resources becomes a limiting factor. To this end, a distributed, scalable implementation of deep neural networks may be used.

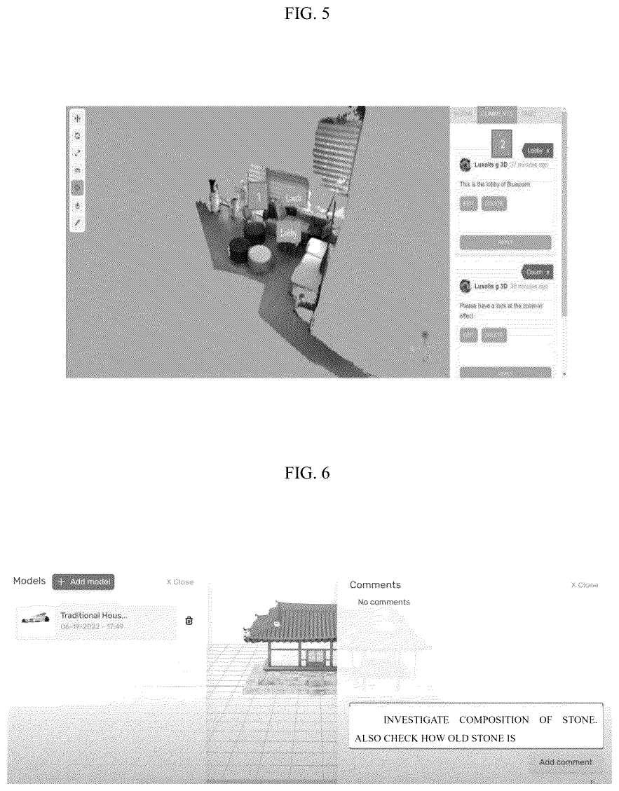

FIG. 6 is a diagram for describing a real-time communication interface based on objects recognized in a platform server and an object list according to an embodiment of the present application.

Referring to FIG. 6, the platform server 300 according to an embodiment of the present application may provide a real-time communication interface based on objects recognized in a generated virtual space and a list of the objects. That is, a plurality of terminals may communicate with the platform server 300, and the plurality of terminals may perform real-time communication based on objects recognized in a virtual space and a list of the objects.

Hereinafter, a method of generating 3D scan data through image registration based on a scan of a broadband LiDAR scanner according to another embodiment of the present application will be described in detail with reference to FIG. 4. FIG. 4 is a flowchart for describing a process of generating 3D scan data according to an embodiment of the present application.

Referring to FIG. 4, first, in operation S101, first data may be obtained from a LIDAR scanner. Here, the first data is a 3D image generated by scanning a scanning target region with a LiDAR scanner.

Specifically, the Lidar scanner may, when a scanning target region is designated by user manipulation, scan the scanning target region, and when the scanning of the scanning target region is completed, generate first data, which is a 3D image generated by scanning the scanning target region. For example, the first terminal may generate RGB-D data for a scanning target region and transmit the RGB-D data to the platform server.

As needed, the platform server may process the obtained data to generate a 3D image. More specifically, the platform server may divide depth data of obtained RGB-D data for each frame and merging the divided depth data, thereby generating a 3D image. The first data may be RGB-D data or processed 3D image data.

In operation S102, the platform server may obtain second data that is a 2D image generated by photographing the scanning target region with a camera. As needed, the server may obtain a 3D image and 2D image data simultaneously captured through a first terminal. The second data may be 2D image data of the target region corresponding to the first data, and as needed, a process of aligning the image origins of the first data and the second data may be further included.

As needed, the first data may have a resolution lower than that of the second data. This is to speed up the process of generating 3D scan data.

In operation S103, first feature data associated with the structure of an object may be obtained from the second data. As needed, operation S103 may further include dividing the second data to form a polygon mesh. This is to improve the accuracy of obtaining the first feature data. As needed, in the obtaining of first feature data, first feature data may be obtained from elements constituting the polygon mesh. The first feature data may be various types of data related to the structure of the object that may be obtained from the second data, and may include data related to at least one type from a set including the color of the polygon mesh, the number of edges of the polygon mesh, the degree of connection of the edges of the polygon mesh, and a vector value of the polygon mesh.

In operation S104, second feature data associated with the texture of an object may be obtained from the second data. As needed, the obtained second feature data may be a 2D image.

In operation S105, when a change value of the first feature data is greater than a preset reference value, the second feature data may be merged with the first data to generate third data. Alternatively, when a change value of the first feature data is greater than or equal to a preset reference value, the second feature data may be merged with the first data to generate third data. In this case, when a change value of the first feature data is smaller than the preset reference value, third data is generated using the first data as it is.

The change value of the first feature data is a value indicating the degree of flatness of the surface of the object. A larger change value represents a surface that is less flat, and a smaller change value represents a surface that is flatter. In this case, when the reference value is set to be lower, higher quality 3D scan data is provided, and the time required to generate the data is increased. Accordingly, the user may set the reference value according to his/her needs.

As needed, an operation of determining the resolution of the second data according to the change value of the first feature data obtained in the operation of generating third data may be included. As needed, the platform server may generate the third data using second data having a higher resolution in response to a greater change value of the first feature data. With such a configuration, a high resolution object whose surface structure rapidly changes may be implemented.

Operation S107 may include recognizing an object through the first data or the third data. The operation of recognizing an object may be performed using AI, and a detailed description thereof will be omitted.

As needed, an operation of generating a list of the recognized objects may be further included.

As needed, a real-time communication interface may be provided based on the recognized objects and the object list.

Since the method of generating 3D scan data according to the present invention merges a high-resolution image with 3D data when the degree of structural change of the object is large, and uses the existing data as it is when the degree of structural change of the object is small, 3D scan data may be generated in a short time while providing 3D scan images with a higher resolution.

Features, structures, effects, etc. described in the above embodiments are included in at least one embodiment of the present invention, and are not limited to only one embodiment. Furthermore, features, structures, effects, etc. illustrated in each embodiment may be combined or modified for other embodiments by those skilled in the art to which the embodiments belong. Accordingly, the content related to such combinations and modifications should be interpreted as being included in the scope of the present invention.

As is apparent from the above, the method of generating 3D scan data according to an embodiment of the present invention merges a high-resolution image with 3D data when the degree of change in the structure of the object is large, and uses the existing data when the degree of change in the structure of the object is small, thereby allowing 3D scan data to be generated in a short time while increasing the resolution of a 3D scan image.

Although the present invention has been described with reference to embodiments, it should be understood by those skilled in the art that the embodiments disclosed above should be not considered as limiting the present invention and various modifications and applications that are not illustrated above are possible without departing from the essential characteristics of the present embodiments. That is, each component specifically shown in the embodiment may be implemented after modification thereof. Differences related to such modifications and applications should be understood as being included in the scope of the present invention defined in the appended claims.

What is claimed is:

1. A method of generating three-dimensional (3D) scan data in which a texture is implemented through image registration based on a scan of a broadband light detection and ranging (lidar) scanner, the method comprising:
when a scanning target region is scanned by the lidar scanner, obtaining first data that is a 3D image generated by scanning the scanning target region with the lidar scanner;
obtaining second data that is a 2D image generated by photographing the scanning target region with a camera;
obtaining first feature data associated with a structure of an object in the second data;
obtaining second feature data associated with a texture of the object in the second data; and
in response to a change value of the first feature data being greater than a preset reference value, merging the second feature data with the first data to generate third data.

2. The method of claim 1, wherein the obtaining of first data includes dividing depth data for each frame, and merging the divided depth data to generate the first data.

3. The method of claim 2, wherein the first data has a resolution lower than a resolution of the second data,
wherein the generating of third data includes, in response to a change value of the first feature data being greater than or equal to a preset reference value, merging the second feature data with the first data to generate the third data.

4. The method of claim 3, further comprising dividing the second data to form a polygon mesh,
wherein the obtaining of first feature data includes obtaining the first feature data from elements constituting the polygon mesh,
the generating of third data includes in response to a change value of the obtained first feature data being greater than or equal a preset reference value, merging the second feature data with the first data to generate the third data.

5. The method of claim 4, wherein the second data is obtained at the same time as obtaining the first data.

6. The method of claim 5, further comprising performing horizontal-vertical (UV) mapping,
wherein the first feature data of the polygon mesh includes data related to at least one type from a set including a color of the polygon mesh, the number of edges of the polygon mesh, a degree of connection of the edges of the polygon mesh, and a vector value of the polygon mesh.

7. The method of claim 6, further comprising recognizing an object through the third data.

8. The method of claim 6, further comprising recognizing an object through the first data.

9. The method of claim 8, wherein the generating of third data includes determining a resolution of the second data according to the change value of the obtained first feature data.

10. A computer readable recording medium on which a program for executing the method of claim 1 is recorded.

11. A platform server for virtual space-based real-time communication, the platform server comprising:
a transceiver configured to receive, from a first terminal, first data generated by scanning a scanning target region with a light detection and ranging (lidar) scanner and second data generated by photographing the scanning target region with a camera; and
a processor configured to generate a virtual space based on the first data and the second data and recognize an object,
wherein the processor is configured to:
extract first feature data associated with a structure of the object in the second data;
extract second feature data associated with a texture of the object in the second data; and
in response to a change value of the first feature data being greater than a preset reference value, merge the second feature data with the first data to generate the virtual space.

12. The platform server of claim 11, wherein the processor is configured to:
recognize at least one object in the virtual space;
generate an object list using the recognized objects; and
control the transceiver to transmit the object list to a second terminal.

13. The method of claim 12, wherein the processor is configured to provide a real-time communication interface based on the object list to the first terminal and the second terminal.
